(19) United States
(12) Patent Application Publication
(10) Pub. No.: US 2008/0040597 A1
(43) Pub. Date: Feb. 14, 2008

(54) Information processing apparatus and controlling method thereof

(75) Inventor: Takashi Hakiri, Ome-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/784,944

(22) Filed: Apr. 9, 2007

(30) Foreign Application Priority Data
Apr. 27, 2006 (JP) 2006-123853

(51) Int. Cl. G06F 9/00

(52) U.S. Cl. 713/2

(57) ABSTRACT

According to one embodiment, an information processing apparatus includes a chip set, an input unit executing inputting of a power-on request, a micro-controller inputting the power-on request to the chip set if the power-on request is input from the input unit, a display unit, if a response signal to the power-on request signal has not been made within a predetermined period after the power-on request signal is input to the chip set, making a display indicating that the response signal has not been made within the predetermined period, and a reset circuit outputting a reset signal to the chip set in accordance with an instruction from the micro-computer if a reset request is input from the input unit after the display unit makes the display indicating that the response signal has not been made within the predetermined period.

### CROSS-REFERENCE TO RELATED APPLICATIONS

This application is based upon and claims the benefit of priority from Japanese Patent Application No. 2006-123853, filed Apr. 27, 2006, the entire contents of-which are incorporated herein by reference.

### BACKGROUND

1. Field

One embodiment of the invention relates to the present invention relates to control of resetting of a notebook-type computer and, particularly, to an information processing apparatus and a controlling method thereof, capable of booting up the computer by executing the resetting even if the computer is not booted up in a case where a power supply is turned on.

2. Description of the Related Art

It is disclosed by, for example, in a notebook-type personal computer having a compulsory boot-up switch as disclosed in, for example, JP-A No. 2002-149260 (KOKAI), compulsory boot-up is executed in a case where the computer system is terminated in an abnormal status after the power supply is completely turned on and an operation of the CPU in the computer is started (cf. JP-A No. 2002-149260 (KOKAI)).

According to the prior art, however, the compulsory boot-up function becomes active after the operation of the CPU of the computer starts. The function cannot be active in a case where the computer system is terminated in an abnormal status before the operation of the CPU of the computer starts.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary a perspective view showing a notebook-type computer serving as an information processing apparatus according to an embodiment of the present invention;

FIG. 2 is an exemplary a block diagram showing a configuration of the notebook-type computer serving as the information processing apparatus according to the embodiment of the present invention; and

FIG. 3 is an exemplary a flowchart showing a method of controlling the information processing apparatus according to the embodiment of the present invention.

### DETAILED DESCRIPTION

Various embodiments according to the invention will be described hereinafter with reference to the accompanying drawings. In general, according to one embodiment of the invention, an information processing apparatus comprises: a chip set; an input unit executing inputting of a power-on request; a micro-controller inputting the power-on request to the chip set if the power-on request is input from the input unit; a display unit, if a response signal to the power-on request signal has not been made within a predetermined period after the power-on request signal is input to the chip set, making a display indicating that the response signal has not been made within the predetermined period; and a reset circuit outputting a reset signal to the chip set in accordance with an instruction from the micro-computer if a reset request is input from the input unit after the display unit makes the display indicating that the response signal has not been made within the predetermined period.

An embodiment of the present invention is described below with reference to the accompanying drawings.

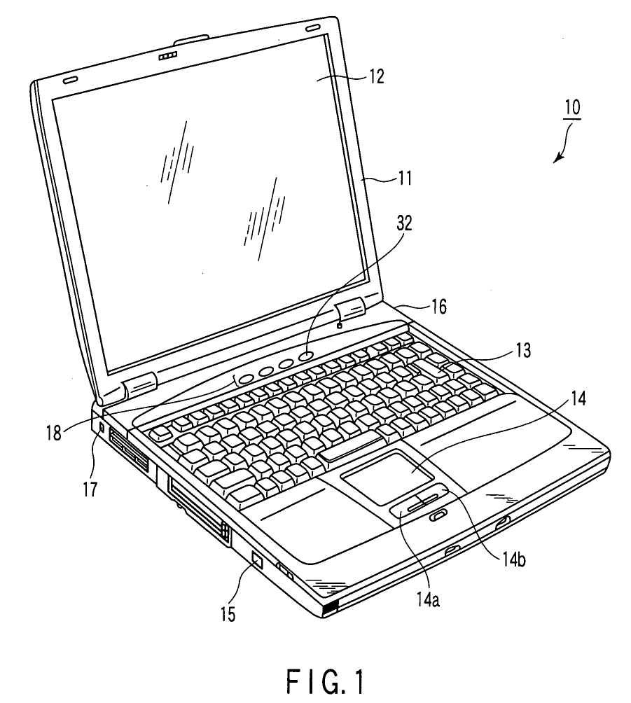

FIG. 1 is a perspective view showing an information processing apparatus according to the embodiment of the present invention. The information processing apparatus is implemented as a battery-operated notebook computer 10.

The computer 10 is composed of a main body 16 and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main body of the computer 10 has a housing shaped in a thin box, and comprises a keyboard 13 on a top face of the housing, a touch pad 14, two buttons 14a, 14b, various short-cut buttons 18 for e-mail, etc., a power button 32, etc. on a palm rest thereof. An optical drive 15, a reset button 17, etc. are provided on side faces of the main body 16.

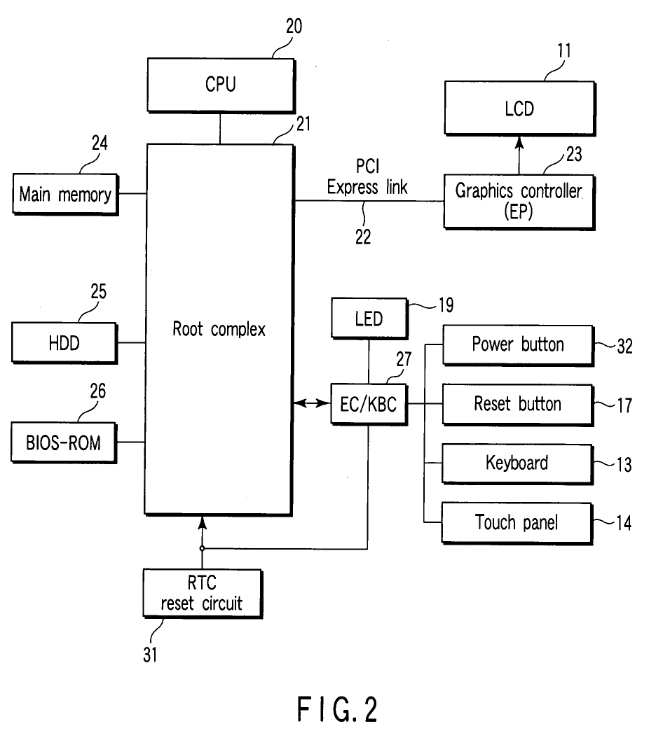

FIG. 2 is a block diagram showing the configuration of the computer.

The computer 10 comprises a CPU (Central Processing Unit) 20, a Root Complex (chip set) 21, a main memory 24, a graphics controller (End Point) 23, a PCI Express Link 22 making a connection between the Root Complex (chip set) 21 and the graphics controller 23, the display unit (LCD) 11, an embedded controller/keyboard controller IC (EC/KBC) 27, a hard disk drive (HDD) 25, a BIOS-ROM 26, etc., together with the reset button 17, the keyboard 13, the touch pad 14, an RTC reset circuit 31, and the LED 19 serving as input devices connected to the EC/KBC 27.

The Root Complex 21, the graphics controller 23, etc. are devices in conformity with the PCI EXPRESS standards. The communications between the Root Complex 21 and the graphics controller 23 are executed over the PCI Express Link 22 arranged between the Root Complex 21 and the graphics controller 23.

The CPU 20 is a processor which controls the operations of the computer 10 to execute various kinds of programs (operating system and application systems) loaded on the main memory 24 by the HDD 25. The CPU 20 also executes the BIOS (Basic Input Output System) stored in the BIOS-ROM 26. The BIOS is a program for controlling the hardware.

The Root Complex 21 is a bridge device which makes a connection between a local bus of the CPU 20 and the graphics controller 23. In addition, the Root Complex 21 also has a function of executing the communications with the graphics controller 23 over the PCI Express Link 22.

The graphics controller 23 is a display controller which controls the display unit 11 employed as a display monitor of the computer.

The EC/KBC 27 is a one-chip microcomputer on which an embedded controller for power management and a keyboard controller controlling the keyboard (KB) 13 and the touch pad 14 are integrated. The EC/KBC 27 has a function of controlling power-on/power-off of the computer 10, in cooperation with a power supply controller, in response to the user's operation of the power button 32. In addition, the EC/KBC 27 drives an RTC reset circuit 31 to output a reset signal to the Root Complex 21 in response to a request from the reset button 17.

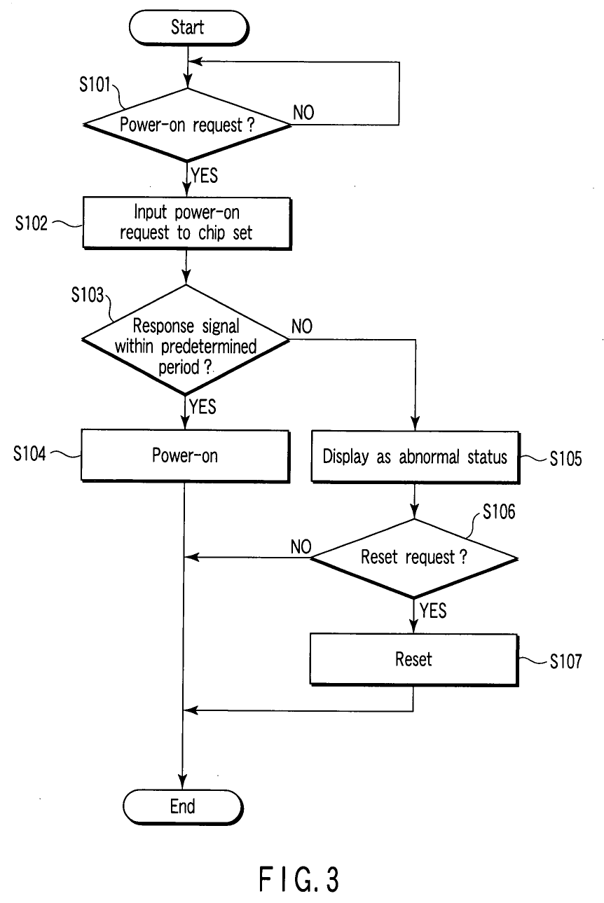

Next, a control method of the information processing apparatus according to the embodiment of the present invention is described with reference to a flowchart of FIG. 3.

In the present embodiment, an operation of turning on the power supply of the computer 10 in a state in which the power supply is not turned on, is described.

When the EC/KBC 27 of the computer 10 receives a power-on request from the power button 32 (YES in step S101), the EC/KBC 27 outputs the power-on request to the Root Complex 21 (step S102). The EC/KBC 27 of the computer 10 discriminates whether or not a response signal from the Root Complex 21 inputting the power-on request is within a predetermined period, for example, 1 to 2 seconds. If it is discriminated by the EC/KBC 27 of the computer 10 that the response signal from the Root Complex 21 inputting the power-on request has been within a predetermined period (YES in step S103), the power supply is turned on (step S104). On the other hand, if it is discriminated by the EC/KBC 27 of the computer 10 that the response signal from the Root Complex 21 inputting the power-on request has not been within a predetermined period (NO in step S103), the EC/KBC 27 urges the display means, for example, the LED 19 to light or blink as the abnormal status (step S105). Otherwise, the EC/KBC 27 may demonstrate a predetermined display on an LCD (not shown) connected to the EC/KBC 27.

Next, the EC/KBC 27 of the computer 10 discriminates whether or not a reset request of the reset button 17 is made (step S106). If it is discriminated by the EC/KBC 27 of the computer 10 that the reset request of the reset button 17 is made (YES in step S106), the EC/KBC 27 drives the RTC reset circuit 31 to output a reset signal to the Root Complex 21 (step S107). When the reset signal is input to the Root Complex 21, a register in the Root Complex 21 is reset.

In the above embodiment, if the EC/KBC 27 of the computer 10 discriminates that the computer 10 is in an abnormal status, the resetting processing is executed in response to the reset request after the abnormal status is displayed on the display means of the LED 19. However, the resetting processing may be executed automatically.

In addition, the computer 10 comprising the reset button 17 is described above. However, the reset request may be made when an operation of combination “power button 32 and a predetermined key” is executed.

According to the above-described embodiment of the present invention, the computer can be normally booted even if the computer system is terminated in an abnormal status irrespective of execution or absence of the operation of the CPU in the computer. Moreover, the computer can be normally booted even if built-in button batteries, etc. cannot be detached to execute the resetting processing in a notebook PC, etc.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a chip set;
an input unit executing inputting of a power-on request;
a micro-controller inputting the power-on request to the chip set if the power-on request is input from the input unit;
a display unit, if a response signal to the power-on request signal has not been made within a predetermined period after the power-on request signal is input to the chip set, making a display indicating that the response signal has not been made within the predetermined period; and
a reset circuit outputting a reset signal to the chip set in accordance with an instruction from the micro-computer if a reset request is input from the input unit after the display unit makes the display indicating that the response signal has not been made within the predetermined period.

2. The apparatus according to claim 1, wherein the display unit is at least one of LED and LCD.

3. The apparatus according to claim 1, wherein the display indicating that the response signal has not been made within the predetermined period is at least one of processing of urging the LED to emit light of a predetermined color and processing of urging the LED to execute the display.

4. The apparatus according to claim 1, wherein if the reset signal is input to the chip set, a register inside the chip set is made clear and reset.

5. A method of controlling boot-up of an information processing apparatus comprising a chip set, an input unit executing inputting of a power-on request, and a micro-controller inputting the power-on request to the chip set if the power-on request is input from the input unit, the method comprising:
if a response signal to the power-on request signal has not been made within a predetermined period after the power-on request signal is input to the chip set, making a display indicating that the response signal has not been made within the predetermined period; and
outputting a reset signal to the chip set in accordance with an instruction from the micro-computer if a reset request is input from the input unit after the display unit makes the display indicating that the response signal has not been made within the predetermined period.
